(19) United States
(12) Patent Application Publication
(10) Pub. No.: US 2026/0366895 A1
(43) Pub. Date: Nov. 19, 2026

(54) SENSOR ASSEMBLY FOR A ROTOR OF AN ELECTRIC MACHINE, AN ELECTRIC MACHINE, AND A METHOD FOR PRODUCING SUCH A SENSOR ASSEMBLY

(71) Applicant: Robert Bosch GmbH, Stuttgart (DE)

(72) Inventors: Christoph Keyl, Stuttgart (DE); Szymon Chmielewski, Abstatt (DE)

(21) Appl. No.: 19/401,728

(22) Filed: Nov. 26, 2025

(30) Foreign Application Priority Data
Dec. 5, 2024 (DE) 10 2024 211 621.1

(51) Int. Cl. G01D 11/24; G01D 5/14; H02K 11/215

(52) U.S. Cl. CPC G01D 11/245; G01D 5/145; H02K 11/215

(57) ABSTRACT

A sensor assembly for a rotor of an electric machine, electric machine and method for producing a sensor assembly. The sensor assembly includes a magnet, a cover part, and a sleeve. The sleeve is connected to the rotor, and the cover part is connected to the sleeve. The magnet is held in the cover part by a shrink-fit connection, in particular a laser shrink-fit connection.

### FIELD

The present invention relates to a sensor assembly for a rotor of an electric machine, to an electric machine, and to a method for producing such a sensor assembly.

### BACKGROUND INFORMATION

Germany Patent Application No. DE 10 2021 205 297 A1 describes a rotor for an electric machine, an electric machine, and methods for producing such a rotor.

Germany Patent Application No. DE 10 2011 112 822 A1 describes an electric motor of a drive assembly in a motor vehicle.

### SUMMARY

According to an example embodiment of the present invention, in a sensor assembly for a rotor of an electric machine, the sensor assembly comprises a magnet, a cover part, and a sleeve, wherein the sleeve is connected to the rotor and the cover part is connected to the sleeve, wherein the magnet is held in the cover part by means of a shrink-fit connection, in particular a laser-shrink-fit connection.

According to the present invention, the magnet can be securely connected to the sensor assembly. In this way, the thermal load or the application of force on the magnet can be reduced, so that sensitive magnets with high magnetic field strength can be used for the sensor assembly. It is advantageous that a defined holding force can be set.

Advantageously, the sensor assembly is used as a rotor position sensor for the electric machine. In this way, the installation space can be reduced.

Here, a shrink-fit connection is understood to mean a press-fit connection that is achieved by means of a shrunken material or by means of a constriction.

A laser shrink-fit connection is further understood to mean a press-fit connection that is achieved by means of a laser-welded laser shrink-fit portion or by means of a constriction. The material is not welded to another workpiece, but only 50% to 80% of the material thickness thereof is welded, so that a weld seam is formed which causes a reduction of an inner diameter of the cover part and/or of the sleeve.

Further advantageous example embodiments of the present invention are disclosed herein.

According to an advantageous example embodiment of the present invention, the cover part comprises a bottom portion and projections, wherein the projections extend along a lateral surface of the magnet and hold the magnet. As a result, the magnet is at least partially surrounded by the cover part, forming a housing.

It is advantageous if the projections are arranged in the radial direction between the magnet and the sleeve, wherein the sleeve comprises at least one laser shrink-fit portion running around the circumference, in particular so that the projections are pressed onto the magnet by means of the laser shrink-fit portion. Thus, a secure connection of the magnet to the cover part is made possible while at the same time a low thermal load or application of force on the magnet is achieved.

It is furthermore advantageous if an inner diameter of the sleeve comprises a shoulder, wherein the bottom portion of the cover part rests on the shoulder so that the bottom portion is arranged between the shoulder and the magnet. As a result, a surface of the magnet facing a magnetic field sensor is uncovered, so that the magnet can act without shielding.

Alternatively, it is advantageous if an inner diameter of the sleeve comprises a shoulder, wherein the magnet rests on the shoulder, so that the magnet is arranged between the shoulder and the bottom portion of the cover part. This ensures a secure connection between the magnet and the sensor assembly. The thickness of the bottom portion is selected in such a way as to minimize the shielding of a magnetic field from the magnet to a magnetic field sensor.

According to a further advantageous example embodiment of the present invention, the cover part is designed to be cup-shaped, wherein the magnet is received in the cover part. As a result, the magnet is at least partially surrounded by the cover part, forming a housing.

It is advantageous if an outer diameter of the sleeve increases in a shoulder-like manner from the magnet to the rotor, wherein the cover part is arranged on the sleeve and extends from a minimum outer diameter of the sleeve to a maximum outer diameter of the sleeve. Thus, the magnet can be pre-assembled between the cover part and the sleeve.

Furthermore, it is advantageous if the cover part has a reduced inner diameter in the region of the minimum outer diameter of the sleeve, in particular a constriction, in particular wherein the cover part comprises a laser shrink-fit connection in the region of the reduced inner diameter. By means of the reduced inner diameter, the cover part can be pressed onto the sleeve, so that the magnet can be positioned on an outer bottom portion of the sleeve.

According to an example embodiment of the present invention, advantageously, the cover part is connected to the sleeve by a material-bonded and/or force-fit connection, in particular in the region of the maximum outer diameter of the sleeve. As a result, the magnet is pre-assembled between the cover part and the sleeve.

According to a further advantageous example embodiment of the present invention, the sleeve is connected to the rotor by a force-fit and/or material-bonded connection, in particular wherein an outer diameter of the rotor is smaller than an outer diameter of the sleeve. The sleeve can be used as a tolerance compensation sleeve between the rotor and the magnet.

According to an example embodiment of the present invention, in the case of the electric machine, the electric machine comprises a rotor and a sensor assembly, in particular as disclosed herein.

According to the present invention is that the sensor assembly can be implemented in a compact manner, so that the required installation space in the electric machine can be reduced.

According to the present invention, in the method for producing a sensor assembly, in particular as disclosed herein, comprising a magnet, a sleeve, and a cover part, the magnet is inserted into the cover part, wherein the cover part and/or the sleeve is subsequently shrunk by means of a laser, so that the magnet is held by the cover part.

According to the present invention, the magnet is securely connected to the sensor assembly. In this way, the thermal load or the application of force on the magnet is reduced, so that sensitive magnets with high magnetic field strength can be used for the sensor assembly. It is advantageous that a defined holding force can be set.

According to an advantageous example embodiment of the present invention, the cover part is connected to the sleeve by a force-fit and/or material-bonded connection before laser shrinking. As a result, pre-assembly of the magnet between the cover part and the sleeve is enabled.

It is advantageous if the sleeve is connected to the rotor in a first method step. Thus, the thermal load on the magnet can be reduced.

Alternatively, it is advantageous if the sleeve is connected to the rotor in a final method step. As a result, the sensor assembly can be manufactured as a pre-assembled unit.

The above example embodiments and developments of the present invention may be combined with one another in any reasonable manner. Further possible embodiments, developments, and implementations of the present invention also include combinations not explicitly mentioned of features of the present invention disclosed herein. A person skilled in the art will in particular also add individual aspects as improvements or additions to the relevant basic form of the present invention, in view of the disclosure herein.

### BRIEF DESCRIPTION OF THE DRAWINGS

In the following section, the preset invention is explained on the basis of exemplary embodiments, from which further inventive features may arise, but the scope of the present invention is not limited thereto. The exemplary embodiments are shown in the figures.

FIG. 1 is a sectional view of a sensor assembly 1 for a rotor according to a first exemplary embodiment of the present invention.

FIG. 2 is a sectional view of a sensor assembly 100 for a rotor according to a second exemplary embodiment of the present invention.

FIG. 3 is a sectional view of a sensor assembly 200 for a rotor according to a third exemplary embodiment of the present invention during a first method step 301.

FIG. 4 is a sectional view of the sensor assembly 200 for a rotor according to the third exemplary embodiment during a second method step 301.

FIG. 5 is a sectional view of the sensor assembly 200 for a rotor according to the third exemplary embodiment of the present invention during a third method step 303.

FIG. 6 is a schematic flowchart of a first variant of a method 300 according to the present invention for producing a sensor assembly (1, 100, 200) for a rotor.

FIG. 7 is a schematic flowchart of a second variant of a method 400 according to the present invention for producing a sensor assembly (1, 100, 200) for a rotor.

### DETAILED DESCRIPTION OF EXAMPLE EMBODIMENTS

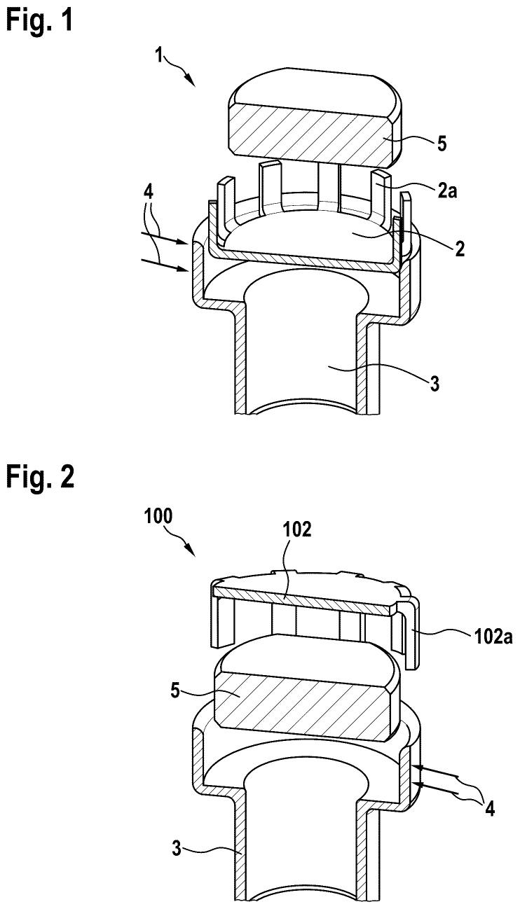

The first exemplary embodiment of the sensor assembly 1 according to the present invention, shown in FIG. 1, comprises a magnet 5, a cover part 2 and a sleeve 3.

The magnet 5 is preferably designed as a permanent magnet, in particular as a neodymium magnet. The magnet 5 is substantially configured in a disk shape and has a circular cross-section. The height of the magnet 5 is smaller than the diameter of the magnet 5.

The sleeve 3 is arranged between the magnet 5 and the rotor, which is not shown in FIG. 1. The sleeve 3 is made of stainless steel. The sleeve is hollow-cylindrical and has a first inner diameter and a second inner diameter. The first inner diameter is arranged facing the rotor. The second inner diameter is arranged facing the magnet 5. The first inner diameter is smaller than the second inner diameter, wherein the inner diameter of the sleeve 3 increases in a shoulder-like manner from the rotor to the magnet; the inner diameter of the sleeve 3 thus comprises a shoulder. The sleeve 3 can be fitted to the rotor and connected to the rotor by a force-fit and/or material-bonded connection, for example by means of welding and/or pressing.

The magnet 5 can be connected to the sleeve 3 by means of the cover part 2. For this purpose, the cover part 2 comprises a circular bottom portion, around the circumference of which a plurality of projections 2a are arranged. The projections 2a in each case extend from the bottom portion along a lateral surface of the magnet 5. The projections 2a are formed in one piece with the bottom portion and are arranged at a right angle, in particular bent, relative to the bottom portion. Advantageously, the projections 2a are arranged in a manner evenly distributed in the circumferential direction of the bottom portion. The height of the projections 2a corresponds substantially to the height of the magnet 5.

According to the first exemplary embodiment, the cover part 2 is arranged in the sleeve 3 and rests with the bottom portion on the shoulder in the sleeve 3. The projections 2a extend from the bottom portion to the magnet 5. The projections 2a are arranged inside the sleeve 3, wherein the sleeve 3 radially surrounds the projections 2a in the region of the second diameter. The magnet 5 rests on the bottom portion and is held by the projections 2a. The magnet 5 is press-fitted to the cover part 2 and the sleeve 3. For this purpose, the sleeve 3 is pressed onto the projections 2a by means of a laser 4. Advantageously, the sleeve 3 comprises two laser shrink-fit portions running around the circumference. A laser shrink-fit portion is a portion in which an outer diameter of the sleeve 3 is shrunk by means of the laser 4 by virtue of the sleeve 3 being laser-welded. No material-bonded connection is formed between the sleeve 3 and the particular projection 2a. The sleeve 3 is not welded through, but only 50% to 80% thereof is welded. This creates a weld seam that reduces the second inner diameter in the region of the particular laser shrink-fit portion, so that the sleeve 3 is pressed together with the cover part 2 and the magnet 5 arranged therein. This joining technique is also known as laser-induced interference fitting.

Advantageously, the cover part 2 is made of aluminum, which allows for good heat dissipation during laser welding. This protects the magnet 5 from thermal overload.

The exemplary embodiment of the sensor assembly shown in FIG. 2 differs from the first exemplary embodiment in that the magnet 5 is arranged between the bottom portion of the cover part 102 and the shoulder of the sleeve 3. The magnet 5 rests on the shoulder. The projections 102a of the cover part 102 extend from the bottom portion to the sleeve 3. The magnet 5 is at least partially surrounded in the circumferential direction by the projections 102a.

The thickness of the bottom portion is selected to be thin enough that the magnetic field of the magnet 5 is not shielded or is only shielded to a minimal extent.

The projections 102a extend into an inner region of the sleeve 3 in the region of the second diameter. The projections 102a are thus arranged between the magnet 5 and the sleeve 3. Thus, the sleeve 3 radially surrounds the projections 102a in the region of the second diameter.

The magnet 5 is press-fitted to the cover part 102 and the sleeve 3. For this purpose, the sleeve 3 is pressed onto the projections 102a by means of a laser 4. Advantageously, the sleeve 3 comprises two laser shrink-fit portions running around the circumference. A laser shrink-fit portion is a portion in which an outer diameter of the sleeve 3 is shrunk by means of the laser 4 by virtue of the sleeve 3 being laser-welded. No material-bonded connection is formed between the sleeve 3 and the particular projection 102a. The sleeve 3 is not welded through, but only 50% to 80% thereof is welded. This creates a weld seam that reduces the second diameter in the region of the particular laser-press portion, so that the sleeve 3 is pressed together with the cover part 102 and the magnet 5 arranged therein.

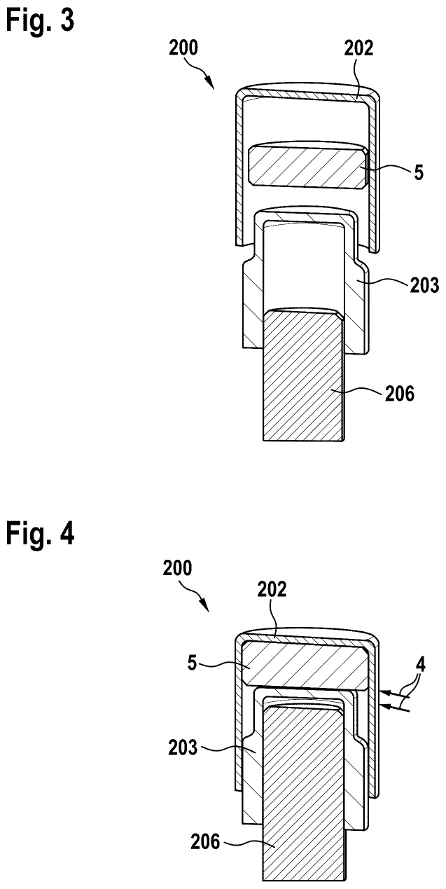

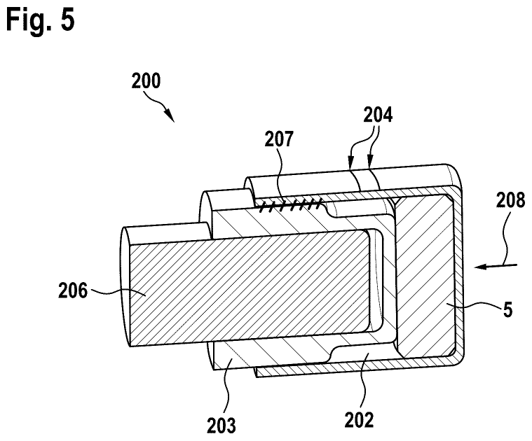

FIGS. 3, 4 and 5 show the third exemplary embodiment of the sensor assembly 200.

The sensor assembly 200 in turn comprises a sleeve 203 for connection to a rotor 206, a magnet 5, in particular a neodymium magnet, and a cover part 202.

The magnet 5 is preferably designed as a permanent magnet, in particular as a neodymium magnet. The magnet 5 is substantially configured in a disk shape and has a circular cross-section. The height of the magnet 5 is smaller than the diameter of the magnet 5.

The cover part 202 is designed to be substantially cup-shaped. The inner diameter of the cover part 202 is slightly larger than the diameter of the magnet 5, so that the magnet 5 can be inserted into the cover part 202. The cover part 202 is preferably made of stainless steel.

The sleeve 203 is substantially designed to be cup-shaped. The inner diameter of the sleeve 203 is large enough that the rotor 206 can be inserted into the sleeve 203 and connected to the sleeve 203 by a material-bonded and/or force-fit connection, for example by means of welding or pressing. The sleeve 203 is preferably made of stainless steel.

The outer diameter of the sleeve 203 comprises a shoulder, wherein the outer diameter of the sleeve 203 decreases from the opening of the sleeve 203 to a bottom portion of the sleeve 203. The minimum outer diameter of the sleeve 203 is smaller than the diameter of the magnet 5. The maximum diameter of the sleeve 203 is substantially the same as the diameter of the magnet 5.

The magnet 5 rests with a first side surface on an outer bottom portion of the sleeve 203 and is held with a second side surface by an inner bottom portion of the cover part 202. The magnet 5 is thus arranged between the outer bottom portion of the sleeve 203 and an inner bottom portion of the cover part 202.

The cover part 202 completely covers the sleeve 206 in the region of the minimum diameter of the sleeve 203. In the region of the maximum diameter of the sleeve 203, the cover part 202 at least partially covers the sleeve 203. The cover part 202 and the sleeve 203 are connected to one another in the region of the maximum diameter of the sleeve 203 by a material-bonded and/or force-fit connection, in particular welded or press-fitted.

In order to fix the magnet 5, the cover part 202 has a reduced inner diameter in the region of the minimum diameter of the sleeve 203, in particular a constriction 204, preferably two constrictions 204 spaced apart in the axial direction. For this purpose, after the cover part 202 has been connected to the sleeve 203, a wall of the cover part 202 in the region of the reduced diameter is shrunk, in particular shrunk by means of a laser 4. The wall of the cover part 202 deforms in such a way that the magnet 5 is pressed onto the sleeve 203.

The magnet 5 is press-fitted to the cover part 202 and the sleeve 203. No material-bonded connection is formed between the sleeve 203 and the wall of the cover part 202 in the region of the reduced diameter of the sleeve 203. The cover part 202 is not welded through, but only 50% to 80% thereof is welded. This creates a weld seam that reduces the inner diameter of the cover part 202 in the region of the particular constriction 204, so that the sleeve 203 is pressed together with the cover part 202 and the magnet 5 arranged therein.

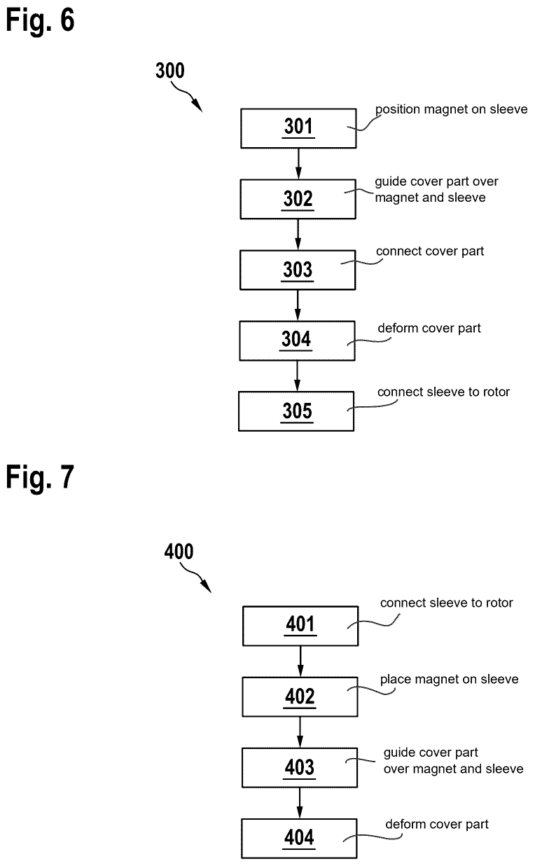

FIG. 6 shows a first variant of the method 300 according to the present invention for producing a rotor 206.

In a first method step 301, a magnet 5 is positioned or placed on a sleeve 203, in particular on an outer bottom portion of the sleeve 203.

In a second method step 302, a cover part 202 is guided over the magnet 5 and the sleeve 203, so that the magnet 5 is arranged between the cover part 202 and the sleeve 203, in particular between an outer bottom portion of the sleeve 203 and an inner bottom portion of the cover part 202.

In a third method step 303, the cover part 202 is connected to the sleeve 203 in the region of a maximum diameter of the sleeve 203 by a force-fit and/or material-bonded connection, in particular welded and/or press-fitted.

In a fourth method step 304, the cover part 202 is deformed in the region of a minimum outer diameter of the sleeve 203, in particular shrunk, so that the inner diameter of the cover part 202 is reduced. Advantageously, a wall of the cover part 202 is laser-shrunk by means of a laser 4. No material-bonded connection is formed between the sleeve 203 and the wall of the cover part 202 in the region of the reduced diameter of the sleeve 203. The cover part 202 is not welded through, but only 50% to 80% thereof is welded. This creates a weld seam that reduces the inner diameter of the cover part 202 in the region of the particular constriction 204, so that the sleeve 203 is pressed together with the cover part 202 and the magnet 5 arranged therein.

In a fifth method step 305, the sleeve 203 is connected to the rotor 206 by a material-bonded and/or force-fit connection, in particular welded.

FIG. 6 shows a second variant of the method 400 according to the present invention for producing a rotor 206.

In a first method step 401, the sleeve 203 is connected to the rotor 206 by a material-bonded and/or force-fit connection.

In a second method step 402, the magnet 5 is placed on the sleeve 203, in particular on an outer bottom portion of the sleeve 203.

In a third method step 403, a cover part 202 is guided over the magnet 5 and the sleeve 203, so that the magnet 5 is arranged between the cover part 202 and the sleeve 203, in particular between an outer bottom portion of the sleeve 203 and an inner bottom portion of the cover part 202. Thereafter, the cover part 202 is connected to the sleeve 203 in the region of a maximum diameter of the sleeve 203 by a force-fit and/or material-bonded connection, in particular welded and/or press-fitted.

In a fourth method step 404, the cover part 202 is deformed in the region of a minimum outer diameter of the sleeve 203, in particular shrunk, so that the inner diameter of the cover part 202 is reduced. Advantageously, a wall of the cover part 202 is laser-shrunk by means of a laser 4. No material-bonded connection is formed between the sleeve 203 and the wall of the cover part 202 in the region of the reduced outer diameter of the sleeve 203. The cover part 202 is not welded through, but only 50% to 80% thereof is welded. This creates a weld seam that reduces the inner diameter of the cover part 202 in the region of the particular constriction 204, so that the sleeve 203 is pressed together with the cover part 202 and the magnet 5 arranged therein.

1-14. (canceled)

15. A sensor assembly for a rotor of an electric machine, the sensor assembly comprising:
a magnet;
a cover part; and
a sleeve;
wherein the sleeve is connected to the rotor, and the cover part is connected to the sleeve, and
wherein the magnet is held in the cover part by a shrink-fit connection.

16. The sensor assembly according to claim 15, wherein the shrink-fit connection is a laser shrink-fit connection.

17. The sensor assembly according to claim 16, wherein the cover part includes a bottom portion and projections, wherein the projections extend along a lateral surface of the magnet and hold the magnet.

18. The sensor assembly according to claim 17, wherein the projections are arranged in a radial direction between the magnet and the sleeve, wherein the sleeve includes at least one laser shrink-fit portion running around a circumference of the sleeve, such that the projections are pressed onto the magnet by the laser shrink-fit portion.

19. The sensor assembly according to claim 17, wherein an inner diameter of the sleeve includes a shoulder, wherein the bottom portion of the cover part rests on the shoulder, and the bottom portion is arranged between the shoulder and the magnet.

20. The sensor assembly according to claim 17, wherein an inner diameter of the sleeve includes a shoulder, wherein the magnet rests on the shoulder, and the magnet is arranged between the shoulder and the bottom portion of the cover part.

21. The sensory assembly according to claim 16, wherein the cover part is cup-shaped, and wherein the magnet is received in the cover part.

22. The sensor assembly according to claim 21, wherein an outer diameter of the sleeve increases in a shoulder-like manner from the magnet to the rotor, wherein the cover part is arranged on the sleeve and extends from a minimum outer diameter of the sleeve to a maximum outer diameter of the sleeve.

23. The sensor assembly according to claim 22, wherein the cover part has a reduced inner diameter in a region of the minimum outer diameter of the sleeve, including a constriction, and wherein the cover part includes a laser shrink-fit connection in a region of the reduced inner diameter.

24. The sensor assembly ccording to claim 22, wherein the cover part is connected to the sleeve by a material-bonded and/or force-fit connection, in a region of the maximum outer diameter of the sleeve.

25. The sensor assembly according to claim 16, wherein the sleeve is connected to the rotor by a force-fit and/or material-bonded connection, and wherein an outer diameter of the rotor is smaller than an outer diameter of the sleeve.

26. An electric machine, comprising:
a rotor; and
a sensor assembly including:
a magnet,
a cover part, and
a sleeve,
wherein the sleeve is connected to the rotor, and the cover part is connected to the sleeve, and
wherein the magnet is held in the cover part by a shrink-fit connection.

27. A method for producing a sensor assembly for a rotor, the sensor assembly including a magnet, a sleeve, and a cover part, the method comprising the following steps:
inserting the magnet into the cover part;
after the inserting, shinking, using a laser, the cover part and/or the sleeve so that the magnet is held by the cover part.

28. The method for producing a sensor assembly according to claim 27, further comprising:
before the shrinking using the laser, connecting the cover part to the sleeve by a force-fit and/or material-bonded connection.

29. The method for producing a sensor assembly according to claim 27, further comprising:
in a first method step of the method or in a last method step of the method, connecting the sleeve to the rotor.
